(19) United States
(12) Patent Application Publication
(10) Pub. No.: US 2006/0076783 A1
(43) Pub. Date: Apr. 13, 2006

(54) Lock device for sliding windows or doors

(76) Inventor: Miao-Hsueh Tsai, Taichung (TW)

Correspondence Address: TSAI MIAO-HSUEH, 3F-5, NO.22, LANE 146, DER-FU ROAD, SOUTH AREAS, TAICHUNG CITY, 402, TW

(21) Appl. No.: 10/960,776

(22) Filed: Oct. 7, 2004

(51) Int. Cl. E05C 19/10

(52) U.S. Cl. 292/24

(57) ABSTRACT

A door or window lock device includes a first part fixed to a door and a gap is defined between the door and the first part. At last one opening is defined through the first part and an adjusting member movably extends through the first part and a section of the adjusting member is located in the gap. At least one hook is pivotably connected in a second part fixed to a jamb a section of the at least one hook extends through the at least one hole so as to extend in the opening and engage with a distal end of the section of the adjusting member.

### FIELD OF THE INVENTION

The present invention relates to a lock device including an adjusting member on the window or door and located beside an opening for receiving a hook, the depth of the adjusting member can be adjusted so that the hook is perfectly engaged with the adjusting member.

### BACKGROUND OF THE INVENTION

A conventional sliding door or window generally includes a first part fixed to the jamb and a second part connected to the door (for example), the second part includes a locking member such as a hook which is pivotably received in a recess and can be pivoted out from the recess to engage a corresponding member via an opening in the first part. The way to pivot the hook can be done by switching a knob or using a key to drive the hook. Theoretically, the hook should hook on a corresponding member such that the door is closely connected to the jamb to lock the door. Nevertheless, the perfect engagement of the hook and the corresponding member requires a lot of factors including the accuracy of machining of the recess for receiving the second part, the installation of the hook and the position of the opening. Either one of the factors fails to meet the requirements, the engagement of the hook and the corresponding member cannot be cooperated as desired.

The present invention intends to provide a simple adjusting member on the second part and the length of the adjusting member at the rear side of the second part can be adjusted so that the hook can be perfectly matched with the adjusting member.

### SUMMARY OF THE INVENTION

The present invention relates to a door or window lock device that comprises a first part fixed to a door and has at last one opening defined therethrough. A gap is defined between the door and the first part. An adjusting member movably extends through the first part and a section of the adjusting member is located in the gap. A second part is fixed to a jamb and includes at least one hole defined therethrough. At least one hook is pivotably connected in the second part and a section of the at least one hook extends through the at least one hole so as to extend in the opening and engage with a distal end of the section of the adjusting member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the lock device of the present invention;

FIG. 2 shows that the hook is engaged with the adjusting member when the door is in lock position;

FIG. 2-1 shows an enlarged view of the engagement of the hook and the adjusting member which is located at a first position;

FIG. 3 shows that the hook is engaged with the adjusting member when the door is in lock position, and

FIG. 3-1 shows an enlarged view of the engagement of the hook and the adjusting member which is located at a second position.

### DETAILED DESCRIPTION OF THE PREFERRED EMBODIMENT

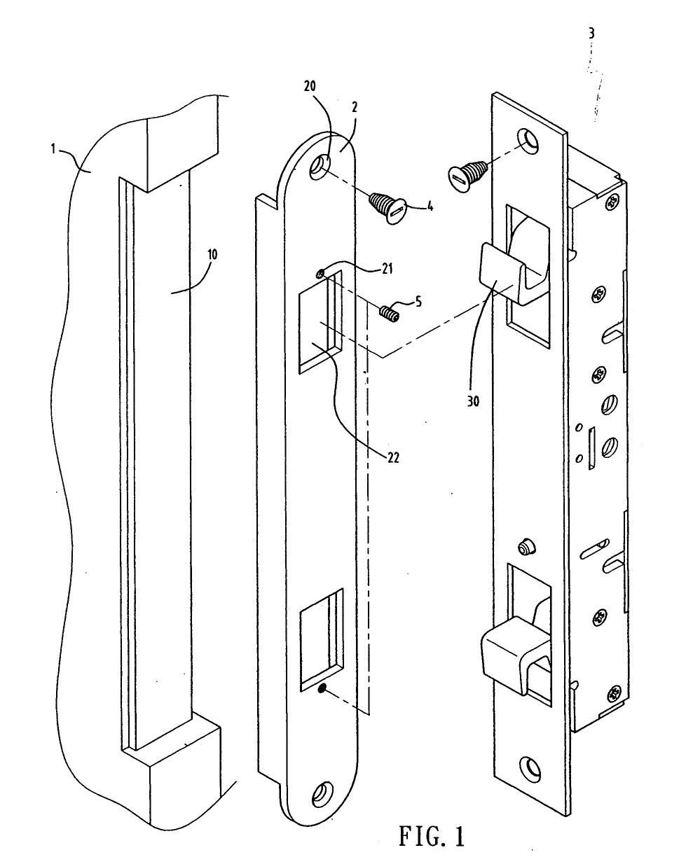

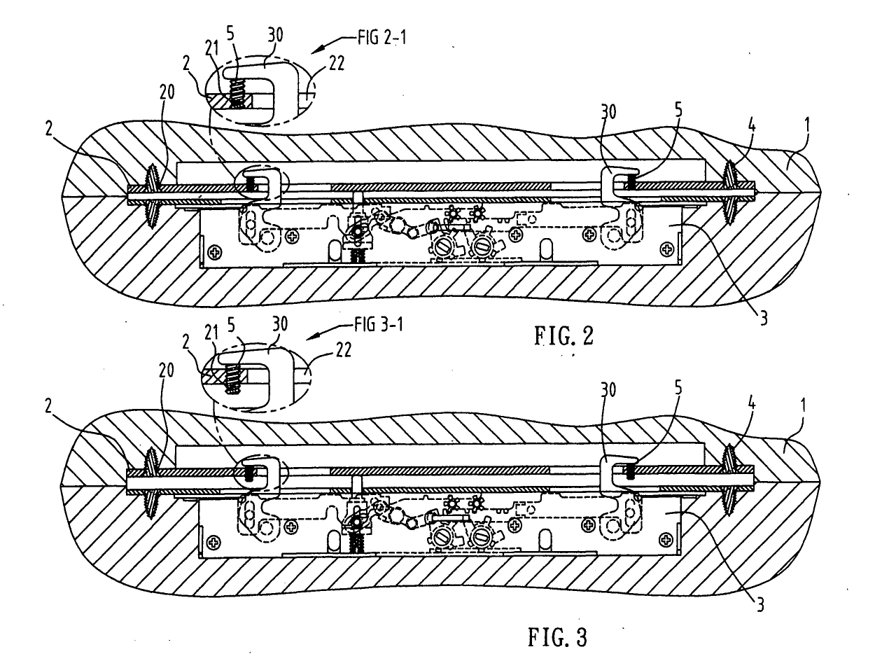

Referring to FIGS. 1, 2 and 2-1, the lock device of the present invention comprises a first part 2 which is fixed to a door 1 and received in a recess 10 defined in an end of the door 1. Two holes 20 are defined through two ends of the first part 2 and screws 4 extend through the two holes 20 and connected to the door 1. Two openings 22 are defined through the first part 2 and a gap is defined between the door 1 and the first part 2. Two adjusting members 5 (only one is shown) such as screws movably extend through two respective threaded holes 21 in the first part 2 and a section of each of the adjusting members 5 is located in the gap.

A second part 3 is fixed to a jamb and includes two holes defined therethrough. Two hooks 30 are pivotably connected in the second part 3 and a section of each of the hooks 30 extends through the corresponding hole so as to extend in the opening 22 and engage with a distal end of the section of the adjusting member 5 to lock the lock device.

As shown in FIGS. 3 and 3-1, the adjusting members 5 can be adjusted by a screw driver (not shown) such that the length of the section of the adjusting member 5 in the gap can be adjusted. This allows the assemblers to adjust the engagement of the hooks 5 and the adjusting members 5 if the first part 2 is installed deeper than the position in FIG. 2.

The present invention provides a simple lock device that is able to adjust the condition of the engagement of the hooks 30 and the adjusting members 5.

While we have shown and described the embodiment in accordance with the present invention, it should be clear to those skilled in the art that further embodiments may be made without departing from the scope of the present invention.

What is claimed is:

1. A door or window lock device comprising:
a first part fixed to a door and having at least one opening defined therethrough, a gap defined between the door and the first part, an adjusting member movably extending through the first part and a section of the adjusting member located in the gap, and
a second part fixed to a jamb and including at least one hole defined therethrough, at least one hook pivotably connected in the second part and a section of at least one hook extending through at least one hole so as to extend in the opening and engage with a distal end of the section of the adjusting member.

2. The lock device as claimed in claim 1, wherein the adjusting member is a screw.
